(19) United States
(12) Patent Application Publication
(10) Pub. No.: US 2010/0060140 A1
(43) Pub. Date: Mar. 11, 2010

(54) FLAT PANEL DISPLAY APPARATUS AND METHOD FOR MANUFACTURING THE SAME

(75) Inventor: Atsushi Miida, Fujisawa-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/546,974

(22) Filed: Aug. 25, 2009

(30) Foreign Application Priority Data
Sep. 8, 2008 (JP) 2008-229656

(51) Int. Cl. H01J 1/62; H01J 9/00

(52) U.S. Cl. 313/496; 445/24

(57) ABSTRACT

In a flat panel display apparatus, a cathode panel having a surface on which a plurality of electron-emitting regions is disposed and an anode panel having a surface on which a plurality of phosphor regions is disposed are provided so that the above two surfaces face each other with a distance provided therebetween, the phosphor regions are covered with an anode, and the anode has a three-layer laminate structure including a first aluminum layer, a second aluminum oxide layer, and third aluminum layer laminated in that order from a phosphor region side.

### BACKGROUND OF THE INVENTION

1. Field of the Invention

The present invention relates to a flat panel display apparatus and a method for manufacturing the same.

2. Description of the Related Art

A field emission display apparatus is an apparatus for displaying various images in which a voltage is applied to a high vacuum region formed between an anode panel and a cathode panel, and electron emitted from an electron emitting device region are radiated to a phosphor region so as to enable a phosphor to emit light. Hence, in a field emission display apparatus, it is important to stabilize withstanding voltage characteristics between an anode panel and a cathode panel.

As one of causes that considerably degrade the withstanding voltage characteristics of the field emission display apparatus, foreign substances present therein may be mentioned. As for foreign substances entering from the outside, appropriate countermeasures may be taken when a process for manufacturing a field emission display device is performed in accordance with a manufacturing method and/or manufacturing environment in which the entry of foreign substances can be reduced as low as possible.

However, in a process for manufacturing a field emission display apparatus, whiskers or hillocks, which are one type of projections, may be generated on an anode made of aluminum in some cases. Incidentally, a needle-shaped projection is called a whisker, and a clumped projection is called a hillock. In addition, the projections as described above may cause discharge in some cases when a voltage is applied to a field emission display apparatus during actual operation. In addition, by an electrostatic force caused by an electric field generated by a voltage applied to a field emission display apparatus during actual operation, projections are peeled off to form foreign substances, thereby considerably degrading the withstanding voltage characteristics of the field emission display apparatus.

It has been believed that in a heat treatment step of a process for manufacturing a field emission display apparatus, these whiskers and hillocks are formed by a compressive stress caused by the difference in thermal expansion between an anode made of aluminum and an underlayer thereof.

As a technique to reduce the generation of whiskers and hillocks on an anode, for example, a technique has been disclosed in Japanese Patent Laid-Open No. 2003-31150 in which the generation of discharge is reduced by covering an anode with an oxide film or a nitride film. However, the generation of whiskers and hillocks causing discharge has not been described.

In addition, in Japanese Patent Laid-Open No. 2007-128701, a technique has been disclosed in which at least one of aluminum and an aluminum alloy is used for an anode, and in which the average thickness of a peripheral portion of the anode is set smaller than that of a central portion thereof. As a result, although the generation of whiskers and hillocks is reduced, the manufacturing method becomes complicated, and hence a simple manufacturing method has been desired.

### SUMMARY OF THE INVENTION

The present invention provides a flat panel display apparatus having a structure that can reduce the generation of whiskers and hillocks on an anode and can reduce the degradation in withstanding voltage characteristics and the generation of discharge, the structure being configured to be simple as compared to that formed by a related technique.

In accordance with one aspect of the present invention, there is provided a flat panel display apparatus that includes a cathode panel having a surface on which a plurality of electron-emitting regions is disposed and an anode panel having a surface on which a plurality of phosphor regions is disposed, in which the surface on which the electron-emitting regions are disposed and the surface on which the phosphor regions are disposed to face each other with a distance provided therebetween. In the flat panel display apparatus described above, the phosphor regions are each covered with an anode, and the anode has a three-layer laminate structure including an aluminum layer (first layer), an aluminum oxide layer (second layer), and an aluminum layer (third layer) laminated in that order from a phosphor region side.

In addition, the anode has a thickness in the range of 70 to 300 nm.

In addition, a method for manufacturing a flat panel display apparatus in accordance with another aspect of the present invention is a method for manufacturing the flat panel display apparatus described above, and this method includes the following steps (a) to (f): (a) covering the phosphor regions disposed on one surface of an anode panel substrate with a resin layer; (b) forming the aluminum layer (first layer) on the resin layer, (c) forming the aluminum oxide layer (second layer) on the aluminum layer (first layer); (d) forming the aluminum layer (third layer) on the aluminum oxide layer (second layer); (e) removing the resin layer by baking to obtain the anode panel; and (f) disposing the surface of the anode panel obtained in step (e) on which the phosphor regions are disposed and the surface of the cathode panel on which the electron-emitting regions are disposed to face each other, so that the flat panel display apparatus is obtained.

In addition, in the manufacturing method described above, in step (c), the aluminum oxide layer (second layer) can be formed by exposing the aluminum layer (first layer) to air.

In addition, in at least one of the steps (b) and (d), the aluminum layer (at least one of the first and the third layers) can be formed by a vacuum deposition method.

According to the present invention, the generation of whiskers and hillocks that cause discharge at the anode can be reduced, and discharge is difficult to occur by a voltage applied during actual operation. In addition, a flat panel display apparatus can be provided that has superior withstanding voltage characteristics, stable operation characteristics, high reliability, and a long life.

Further features of the present invention will become apparent from the following description of exemplary embodiments with reference to the attached drawings.

### BRIEF DESCRIPTION OF THE DRAWINGS

FIG. 1 is a perspective view showing a flat panel display apparatus.

FIG. 2 is a cross-sectional view showing an anode panel.

FIG. 3 is a schematic view showing a method for forming an anode.

### DESCRIPTION OF THE EMBODIMENTS

A flat panel display apparatus according to an embodiment of the present invention has a cathode panel in which a plurality of electron-emitting regions is provided on a supporting member and an anode panel in which a plurality of phosphor regions and an anode are provided. The cathode panel and the anode panel are bonded to each other with a support frame provided along the peripheries thereof to have a predetermined distance between the anode and the cathode panels.

In particular, in a flat panel display apparatus incorporating a cathode panel that includes electron-emitting devices, it is important to stabilize the withstanding voltage characteristics between the cathode panel and the anode panel, and an embodiment of the present invention is suitably applied to the flat panel display apparatus as described above.

The anode has a function to bombard the phosphor region with electrons emitted from the electron-emitting region by applying a voltage between the anode and the electron-emitting region of the cathode panel. In addition, the anode also has functions to release electrostatic charge generated on the phosphor region therethrough and to guide visible light generated in the phosphor region to the front surface of the flat panel display apparatus by reflection.

The flat panel display apparatus according to aspects of the present invention has the structure in which surfaces of the phosphor regions disposed on an anode panel substrate that face the cathode panel are covered with the anode (layer), and the anode includes three layers, that is, an aluminum layer (first layer), an aluminum oxide layer (second layer), and an aluminum layer (third layer), laminated in that order from a phosphor region side. The phosphor regions may be formed on the anode panel substrate using a known material and a known method and, whenever necessary, may be provided together with a light absorption layer and/or a partition layer. These light absorption layer and partition layer may also each be formed using a known material and a known method. For example, a material having properties similar to those of an insulating material may be used for the light absorption layer, and a material having both conductive and insulating properties may be used for the partition layer. In addition, the anode may be formed by a method which will be described later.

Since the aluminum oxide layer is provided between the aluminum layers that form the anode, the generation of whiskers and hillocks can be reduced. Hence, even when a voltage is applied during actual operation, the generation of discharge can be reduced.

The anode preferably has a thickness in the range of 70 to 300 nm. When the thickness is more than 300 nm, a barrier effect (Dead Voltage) generated when electrons emitted from the electron-emitting region pass through the anode is increased, and the luminance from the phosphor region may be decreased in some cases. On the other hand, when the thickness is less than 70 nm, light emitted from the phosphor region cannot be sufficiently guided to the front surface (substrate direction of the anode panel) of the display device by reflection on the anode, and the luminance may be decreased in some cases. The thickness of the anode is more preferably in the range of 80 to 140 nm.

In addition, although the thickness of the aluminum oxide layer of the anode is not particularly limited, it is preferable in the range of 1 to 10 nm. The thickness is preferably 1 nm or more since the growth of whiskers in the aluminum layer is blocked. The thickness is preferably 10 nm or less since the reflectance of the anode can be maintained without being decreased.

In addition, in the anode according to aspects of the present invention, as long as the three layers, that is, the aluminum layer (first layer), the aluminum oxide layer (second layer), and the aluminum layer (third layer), are formed, it is not necessary for each of the layers to have a uniform thickness. In addition, as long as the whole laminate structure of the three layers functions as an electrode, a non-layered portion may be partly present in the laminate.

Incidentally, the anode may be a laminate including a plurality of three-layer laminate structures laminated to each other, each of the three-layer laminate structures being formed of the aluminum layer (first layer), the aluminum oxide layer (second layer), and the aluminum layer (third layer). In addition, the topmost surface of the anode is preferably formed of an aluminum oxide layer (that is, an aluminum oxide layer is disposed on the third aluminum layer). Furthermore, a getter layer is also preferably provided on the anode.

A method for manufacturing the flat panel display apparatus according to an embodiment of the present invention includes the following steps (a) to (f): (a) covering a plurality of phosphor regions disposed on one surface of an anode panel substrate with a resin layer; (b) forming an aluminum layer (first layer) on the resin layer; (c) forming an aluminum oxide layer (second layer) on the aluminum layer (first layer); (d) forming an aluminum layer (third layer) on the aluminum oxide layer (second layer); (e) removing the resin layer by baking to obtain an anode panel; and (f) disposing a surface of the anode panel obtained in step (e) on which the phosphor regions are disposed and a surface of a cathode panel on which a plurality of electron-emitting regions is disposed to face each other, so that the flat panel display apparatus is obtained.

In order to form a flat anode on the phosphor regions, the phosphor regions provided on one surface of the anode panel substrate are each covered with the resin layer in step (a). Although a resin forming the resin layer is not particularly limited, an acrylic resin or an ethyl cellulose resin is preferably used in view of both the flatness and the pyrolytic characteristics.

The resin layer may be formed, for example, by a screen printing method, a slit coating method, or a spray coating method. In addition, in order to form the resin layer only on the phosphor regions, after the resin layer is formed over the entire surface by the method mentioned above, areas of the resin layer other than the phosphor regions may be removed by a lithography technique.

In step (b), the aluminum layer (first layer) is formed on the resin layer. The aluminum layer (first layer) may be formed by a physical vapor deposition (PVD) method, such as a vacuum deposition method or a sputtering method.

In step (c), the aluminum oxide layer (second layer) is formed on the aluminum layer (first layer). The aluminum oxide layer (second layer) may be formed by exposing the aluminum layer (first layer) to the atmosphere (air). This method is preferable since the aluminum oxide layer (second layer) can be easily formed to have a desired thickness. Alternatively, the aluminum oxide layer (second layer) may be formed by depositing aluminum while a very small amount of oxygen is supplied under high vacuum conditions. In addition, the aluminum oxide layer (second layer) may be formed by sputtering an aluminum oxide target.

In step (d), the aluminum layer (third layer) is formed on the aluminum oxide layer (second layer). The aluminum layer (third layer) may be formed by a method similar to that for the aluminum layer (first layer).

In step (e), the resin layer is removed by baking, so that the anode panel is obtained. Although the temperature of the baking depends on the type of resin layer, a temperature of 400 to 500° C. is preferable in consideration of the heat resistance of the phosphor and is also preferable since the resin can be completely baked out. By controlling oxygen in an atmosphere in step (e), the topmost surface of the anode may be formed into an aluminum oxide layer (an aluminum oxide layer is formed on the third aluminum layer).

In step (f), the surface of the anode panel obtained in step (e) having the phosphor regions and the surface of the cathode panel having a plurality of the electron-emitting regions are disposed to face each other, so that the flat panel display apparatus is obtained.

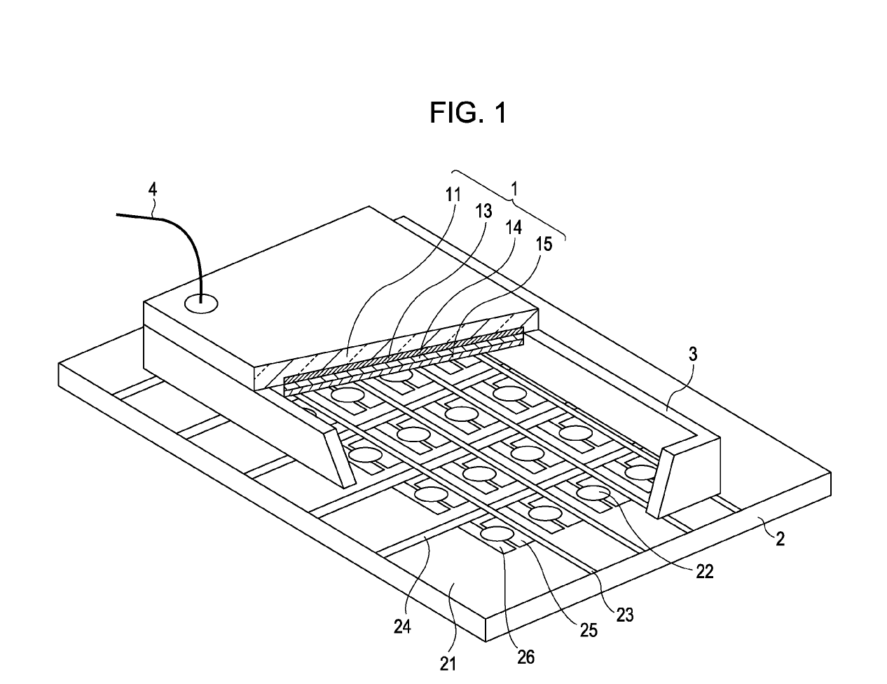

Referring to FIG. 1, one embodiment of the present invention will be described in detail using a flat panel display apparatus that includes surface-conduction electron-emitting devices provided on electron-emitting regions by way of example.

The flat panel display apparatus according to aspects of the present invention includes a cathode panel 2 in which a plurality of electron-emitting regions is provided on a substrate and an anode panel 1 in which a plurality of phosphor regions and an anode are provided on a substrate. The cathode panel 2 and the anode panel 1 are bonded to each other at peripheral portions thereof with a support frame 3 interposed therebetween. In addition, a space surrounded by the cathode panel 2 and the anode panel 1 is placed in a vacuum state (for example, at 10⁻³ Pa or less). In addition, the electron-emitting regions provided on the cathode panel 2 are disposed in a two-dimensional matrix, and the phosphor regions provided on the anode panel 1 are disposed so as to face the respective electron-emitting regions.

The electron-emitting regions are formed of (A) scanning wires 23 and scanning electrodes 25 formed on a substrate 21, (B) an insulating layer formed on the scanning wires 23, (C) signal wires 24 and signal electrodes 26 formed on the insulating layer, and (D) electron-emitting devices 22 formed between the respective scanning electrodes 25 and signal electrodes 26 so as to be connected thereto.

Incidentally, the electron-emitting device 22 provided in the corresponding electron-emitting region according to aspects of the present invention may be formed of a spinto-type field emission device or a carbon nanotube-type field emission device.

In the cathode panel 2, the scanning wires 23 are strip-shaped wires extending in a first direction (X direction), and the signal wires 24 are strip-shaped wires extending in a second direction (Y direction) different from the first direction. The scanning wires 23 and the signal wires 24 extend in the directions orthogonal to each other to form a stripe pattern in each direction. In the electron-emitting region corresponding to one subpixel, the surface-conduction electron-emitting device 22 is provided on the scanning electrode 25 connected to the scanning wire 23 and the signal electrode 26 connected to the signal wire 24.

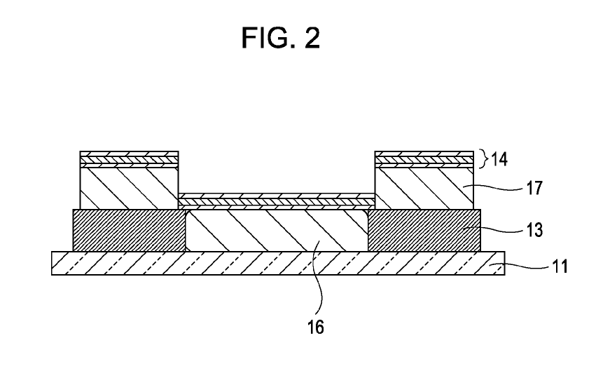

In addition, in the anode panel 1, phosphors (not shown), a light absorption layer (black matrix) 13, an anode 14, a non-evaporable getter (NEG) 15 are formed on an inside surface of a substrate 11. FIG. 2 is a cross-sectional view of the anode panel 1. The anode panel 1 includes the substrate 11, phosphors 16 formed thereon, and the anode 14. In addition, the light absorption layer (black matrix) 13 and a partition layer 17 are formed on the substrate 11 between the phosphors 16. Furthermore, between the cathode panel 2 and the anode panel 1, spacers (not shown) are disposed, and the support frame 3 is disposed at substrate peripheral portions.

In the flat panel display apparatus according to aspects of the present invention, the scanning electrodes 25 are connected to a scanning wire control circuit, the signal wires 24 are connected to a signal wire control circuit, and the anode 14 is connected to an anode control circuit. These circuits may be formed from known circuits. During actual operation of the flat panel display apparatus, an anode voltage Va applied to the anode 14 is generally constant, and for example, a voltage of 5 to 15 kilovolts may be used.

During actual operation of the flat panel display apparatus according to aspects of the present invention, a relatively negative voltage is applied to the scanning electrode 25 from the scanning wire control circuit, and a relatively positive voltage is applied to the signal electrode 26 from the signal wire control circuit. In addition, a positive voltage (anode voltage Va) higher than that applied to the signal electrode 26 is applied to the anode 14 from the anode control circuit.

By a drive voltage (Vf) generated between the scanning electrode 25 and the signal electrode 26, electrons are emitted from the electron-emitting region in accordance with the quantum tunnel effect, and the electrons thus emitted pass through the anode 14 and collide against the phosphor 16. As a result, the phosphor 16 is excited to emit light, so that a desired image can be obtained. That is, the operation of the flat panel display apparatus is basically controlled by a voltage applied to the scanning electrode 25 and by a voltage applied to the signal electrode 26.

### EXAMPLES

Hereinafter, the present invention will be described in detail with reference to examples; however, the present invention is not limited thereto.

### Example 1

In this example, a method for manufacturing a flat panel display apparatus in which electron-emitting regions are formed of surface-conduction electron-emitting devices will be described by way of example. First, a cathode panel having surface-conduction electron-emitting devices is formed in accordance with the following manufacturing method.

After a scanning electrode layer and a signal electrode layer, each formed of platinum, were formed on a substrate made of a soda lime glass by a sputtering method, patterning was performed using a lithography and an etching technique, so that scanning electrodes and signal electrodes were formed.

Subsequently, after a scanning-wire conductive layer was formed by a screen printing method using a silver paste, patterning was performed by a lithography technique, followed by performing a baking treatment, so that strip-shaped scanning wires were formed. On the scanning wires, an insulating film of SiO₂ was formed.

Furthermore, after a signal-wire conductive layer was formed on the insulating layer using a silver paste as in the above scanning wires and was then patterned by a lithography technique, a baking treatment was performed, so that strip-shaped signal wires were formed. The strip-shaped signal wires were disposed to extend perpendicularly to the scanning wires.

Finally, after a material including palladium oxide to be formed into electron-emitting devices was applied by an ink-jet method between the scanning wires and the signal wires, a pulse voltage was applied therebetween, so that the surface-conduction electron-emitting devices were formed. As described above, the cathode panel was obtained in which a plurality of surface-conduction electron-emitting devices was formed on the substrate.

In addition, an anode panel was formed in accordance with the following manufacturing method. The anode panel of Example 1 included phosphor regions; a light absorption layer and a partition layer, which were each provided at a place other than the phosphor regions; and an anode covering these constituent elements.

First, a two-dimensional matrix light absorption layer (black matrix) was formed on a substrate. Next, on the light absorption layer (black matrix), the partition layer (ribs) was formed. Furthermore, the phosphor regions were formed on exposed portions of the substrate surrounded by the light absorption layer (black matrix). In addition, resin layers were formed on the phosphor regions. In particular, after a solid resin layer was formed on the entire surface by a screen printing method, the resin layers were formed only on the phosphor regions by a lithography technique.

As described above, the phosphor regions covered with the resin layers, the light absorption layer surrounding the phosphor regions, and the partition layer were formed on the substrate. Subsequently, an anode including aluminum and aluminum oxide was formed over the entire surface, that is, was formed to cover the phosphor regions covered with the resin layers, the light absorption layer surrounding the phosphor regions, and the partition layer.

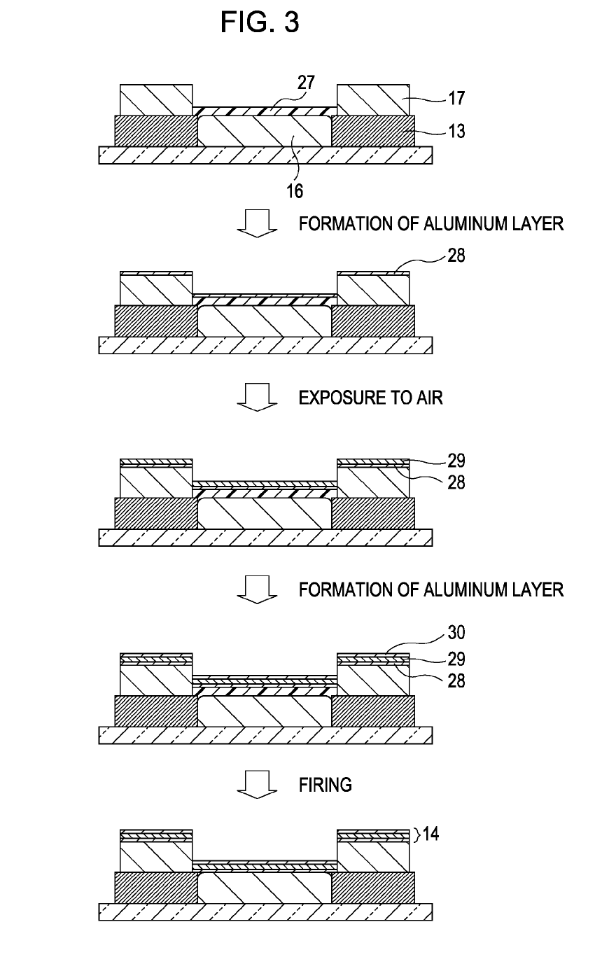

FIG. 3 is a schematic view showing a method for forming the anode of Example 1. As a method for forming an anode 14 including aluminum and aluminum oxide, an aluminum layer (first layer) 28 was first formed in a vacuum deposition apparatus. As for the conditions of the vacuum deposition, an aluminum ingot having a purity of 99.999% was used as a starting material, and electron beams corresponding to 0.5 A at 10 kV were radiated under an ultimate vacuum of 10⁻⁴ Pa or lower, so that the film formation was performed at a deposition rate of 555 nm/sec. As a result, the aluminum layer (first layer) 28 having a thickness of 60 nm was formed.

Subsequently, this aluminum layer (first layer) 28 was once exposed to air, so that an aluminum oxide layer (second layer) 29 was formed. As a result, the aluminum oxide layer (second layer) 29 having a thickness of several nanometers was obtained.

Next, an aluminum layer (third layer) 30 was formed again in the vacuum deposition apparatus under conditions equivalent to those for the formation of the aluminum layer (first layer) 28. As a result, the aluminum layer (third layer) 30 having a thickness of 60 nm was obtained, and the anode 14 including the two aluminum layers and the aluminum oxide layer provided therebetween was formed.

Finally, the resin layers were removed by performing a baking treatment. In particular, the resin layers were baked at 450° C. The resin layers were burnt away and removed by this baking treatment, so that the anode including aluminum and aluminum oxide was allowed to remain on the phosphor regions, the light absorption layer, and the partition layer. Incidentally, gasses generated by combustion of the resin layers were discharged outside, for example, through fine holes formed in conductive material layers.

By the process described above, the anode panel was completed. Next, the flat panel display apparatus was then assembled. In particular, spacers were fitted to a spacer holding portion provided on the partition layer of the anode panel, and the anode panel and the cathode panel were disposed so that the phosphor regions and the electron-emitting regions faced each other.

Subsequently, the peripheral portions of the two panels were bonded to each other with a support frame interposed therebetween, the support frame being formed of a metal frame member having a height of 1.6 mm and an adhesive layer composed of a frit glass. When this bonding was performed in a high vacuum atmosphere (10⁻⁴ Pa), a space surrounded by the bonding portion between the anode panel and the cathode panel was evacuated, so that the above space was placed under a vacuum condition. By the steps described above, the flat panel display apparatus was formed.

By surface observation, it was confirmed that whiskers were not generated on the anode formed by the method for forming an anode according to this example. In order to confirm the generation of whiskers, when the anode panel was completed, 25 points on a surface of a faceplate were observed by an optical microscope, and whenever necessary, observation was performed using a scanning electron microscope. As a result, the number of generated whiskers was zero.

In addition, during actual operation of the flat panel display apparatus thus formed, discharge was difficult to occur, the withstanding voltage characteristics were superior, and stable operation characteristics were obtained. The number of whiskers generated on the anode formed in this example and the withstanding voltage characteristics of the flat panel display apparatus are shown in Table 1.

### Comparative Example 1

In Comparative Example 1, a flat panel display apparatus was formed using an anode that was formed of one aluminum layer having the same thickness as the total thickness of the anode of Example 1. As a result, by surface observation of the anode, many whiskers were confirmed. In addition, during actual operation of the flat panel display apparatus, discharge starting from whiskers frequently occurred. The number of whiskers generated on the anode formed in this comparative example and the withstanding voltage characteristics of the flat panel display apparatus are shown in Table 1.

TABLE 1

| | | Number of | Withstanding |
|---|---|---|---|
| | Structure of | generated | voltage |
| | Anode | whiskers | characteristics |
| Example 1 | Aluminum/aluminum | 0 | ◯ (no discharge |
| | oxide/aluminum: | | by voltage |
| | three-layer | | application during |
| | structure | | actual operation) |
| Comparative | Aluminum: one- | 35 | X (frequent |
| Example 1 | layer structure | | occurrence of |
| | | | discharge starting |
| | | | from whiskers by |
| | | | voltage |
| | | | application during |
| | | | actual operation) |

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-229656 filed Sep. 8, 2008, which is hereby incorporated by reference herein in its entirety.

What is claimed is:

1. A flat panel display apparatus comprising:
a cathode panel having a surface on which a plurality of electron-emitting regions is disposed; and
an anode panel having a surface on which a plurality of phosphor regions is disposed, in which the surface on which the electron-emitting regions are disposed and the surface on which the phosphor regions are disposed to face each other with a distance provided therebetween,
wherein the phosphor regions are covered with an anode,
the anode includes a first aluminum layer, a second aluminum layer, and an aluminum oxide layer provided between the first and the second aluminum layers, and
the first aluminum layer, the aluminum oxide layer, and the second aluminum layer are provided in that order on the phosphor regions.

2. The flat panel display apparatus according to claim 1,
wherein the anode has a thickness in the range of 70 to 300 nm.

3. A method for manufacturing the flat panel display apparatus according to claim 1, comprising the steps of:
(a) covering the phosphor regions disposed on one surface of an anode panel substrate with a resin layer;
(b) forming the first aluminum layer on the resin layer;
(c) forming the aluminum oxide layer on the first aluminum layer;
(d) forming the second aluminum layer on the aluminum oxide layer;
(e) removing the resin layer by baking to obtain the anode panel; and
(f) disposing the surface of the anode panel obtained in step (e) on which the phosphor regions are disposed and the surface of the cathode panel on which the electron-emitting regions are disposed to face each other, so that the flat panel display apparatus is obtained.

4. The method according to claim 3,
wherein, in step (c), the aluminum oxide layer is formed by exposing the aluminum layer formed on the resin layer to air.
